(19) United States
(12) Patent Application Publication
(10) Pub. No.: US 2005/0100430 A1
(43) Pub. Date: May 12, 2005

(54) Utility cart lifting platform

(76) Inventor: Slobodan David Davidovic, Weymouth, MA (US)

Correspondence Address: SLOBODAN DAVID DAVIDOVIC, 38 MASSEY DR., CHARLOTTETOWN, PE, C1E 1R6, CA

(21) Appl. No.: 10/690,959

(22) Filed: Oct. 23, 2003

(51) Int. Cl. B65F 9/00; B65G 67/00

(52) U.S. Cl. 414/336

(57) ABSTRACT

A utility cart unloading system that is both functional and necessary. The system includes lifting platform that fits inside dimension of a cart and is attached with two sheets of canvas on each side to two steel tubes which are than installed into a metal frame that fits onto the top rim of a cart. An electrical DC motor rotates the steel tubes clockwise and counterclockwise simultaneously by means of chain transmission in the same direction at the same time and at the same speed and is controlled by rocker switch. By winding the canvas around the steel tubes, the lifting platform travels up and the contents of the cart are lifted.

### FIELD OF THE INVENTION

The present invention relates to utility carts and, more particularly, to laundry carts and carts that are loaded with square shaped objects and boxes that automatically-on demand lift the contents to a waist-high level.

### BACKGROUND OF THE INVENTION

Ever since utility carts (baskets) were invented and put to use, there has been a need to unload them. A functional and easy to use unloading system was desired by the operators from the earliest days of use of the carts. However, in the early days the carts were not used as frequently and their occasional unloading was not considered a serious problem. Only in the last few decades due to widespread use of carts in the service industry such as dry cleaning, laundry, hospitality and postal offices back injury problems were realized and acknowledged, and the need for a solution increased dramatically. For example the Government of the United States through OSHA has issued ergonomic guidelines and regulations addressing bending and lifting in the workplace. Again, as a result of the increased stress and an ever-demanding work load, workers are increasingly forced to unload utility carts on an average of 15 to 20 times a day, multiplied by the number of items in the carts. Therefore, the need for a device to help unload utility carts is clear and critical.

One device available today that is used to help unload utility carts is a spring-loaded platform. The platform is a canvas wrapped steel frame that hangs inside a cart with four to six springs attached to the top rim of the cart. The load itself, if it is heavy enough, expands the springs and allows the platform to move down to the bottom. As one unloads the cart the springs lift the platform, therefore helping an operator reach the items in the cart. Normally the platform stops midway in the cart due to the length of the springs.

Another unloading system is stationary steel tank with a mesh material sling inside, which travels to the bottom/bare floor. Wet clothes are dumped from a conveyer into the tank and the sling is made to raise the clothes for unloading by rolling up around a long thin rollers permanently connected to the back wall of the tank. The roller is powered by a large industrial motor, four foot long chain, and industrial gearbox controlled by a floor mounted foot pedal switch.

U.S. patent application Ser. No. 10/170,844 by Davidovic describes unloading system which uses motorized sling to unload bulk loads like clothing and sheets.

U.S. Pat. No. 3,870,367 by O'Brien describes a hand propelled loading cart utilizing a flexible load release sheet that is used to damp bulk loads.

Prior art cart unloading systems are all made to deal with loose bulk loads such as cloths and sheets. Those systems can not be used to load and ultimately unload square shaped objects or boxes. In contrast to loading loose loads that can be just dumped into a cart, loading boxes is as laborious job as unloading them.

Heretofore, no device has been created to fulfill the need for unloading the carts regardless of the shape or the weight of the load.

It is therefore an object of the invention to help with the unloading of utility carts

It is another object of the invention to eliminate back injuries

It is another object of the invention to eliminate back, arm, shoulder, leg and neck strain.

It is another object of the invention to eliminate blood pressure to the head caused by bending over.

It is another object of the invention to completely eliminate the need to bend while reaching for items on the bottom of a cart.

It is another object of the invention to increase worker productivity by speeding up the unloading and sorting of items coming out of the cart.

### SUMMARY OF THE INVENTION

In accordance with the present invention, there is provided a utility cart loading/unloading system that is both functional and necessary. The system includes lifting platform that fits inside dimension of a cart and is attached with two sheets of canvas on each side to the two steel tubes which are than installed into a metal frame that fits onto the top rim of a cart. An electrical DC motor rotates the steel tubes clockwise and counterclockwise simultaneously by means of chain transmission in the same direction at the same time and at the same speed and is controlled by rocker switch. By winding the canvas around the steel tubes, the lifting platform travels up and the contents of the cart are lifted.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a lifting platform in use in accordance with the invention;

FIG. 2 is a perspective view of a cover that protects moving parts such as rotating tubes and steel chain;

FIG. 3 is a perspective view of a lifting platform equipped with an electrical dc motor that is highly movable;

FIG. 4 is a perspective view of an utility cart;

FIG. 5 is a top view of a lifting platform equipped with an electrical dc motor in relation with rotating tubes and steel chain;

FIG. 6 is a cross sectional view of a power tube assembly with an electrical dc motor used in lifting platform system;

FIG. 7 is a side view of a lifting platform equipped with an electrical dc motor and position of battery pack and battery dock;

FIG. 8 is a cross sectional view of a power tube equipped with an electrical ac tubular motor used in another embodiment of the invention;

FIG. 9 is a perspective view of a lifting platform equipped with an electrical ac tubular motor used in another embodiment of the invention; and

FIG. 10 is a perspective view of a lifting platform equipped with two electrical ac tubular motors used in yet another embodiment of the invention.

For purposes of clarity and brevity, like elements and components will bear the same designations and numbering throughout the FIGURES.

### DESCRIPTION OF THE PREFERRED EMBODIMENT

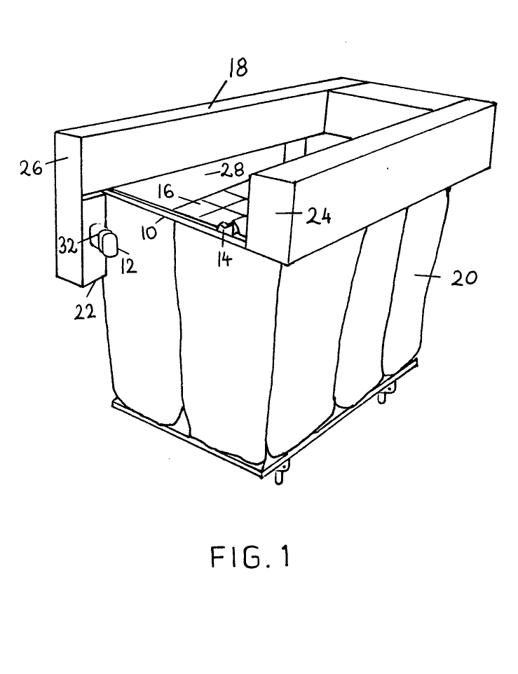

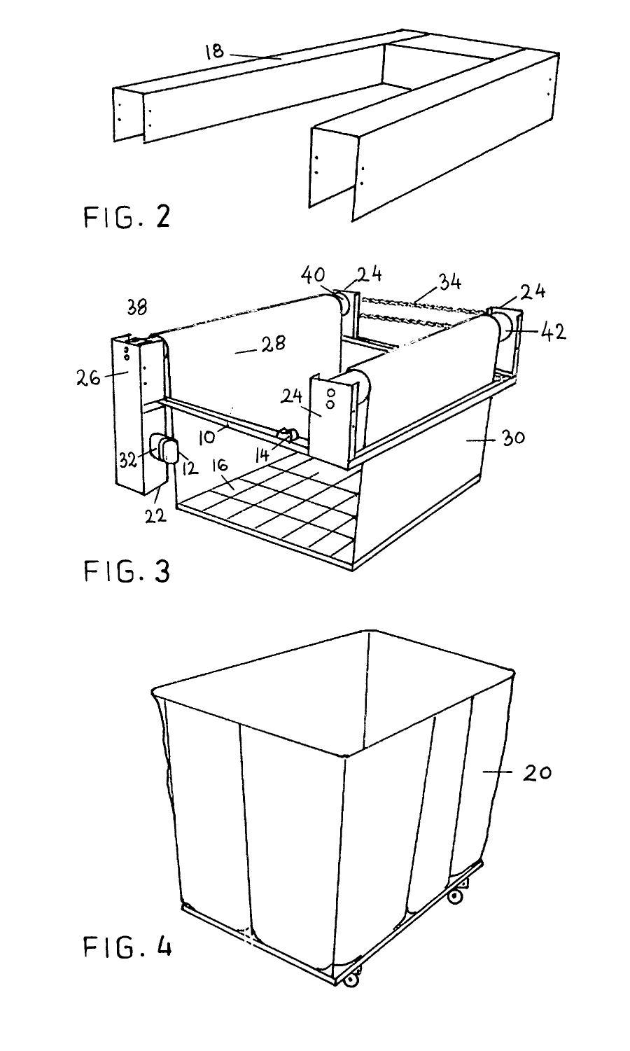

Generally speaking, the invention pertains to a utility cart 20 lifting platform 16 unloading system that helps with the unloading of utility carts, in order to prevent bending when loading a cart 20 with boxes as well as reaching the items on the bottom of a cart 20 when unloading, thus preventing back injuries. FIG. 1, illustrates the utility cart 20 lifting platform 16 of this invention. The utility cart 20 lifting platform 16 system includes an electrical motor, power and powered tubes, a chain transmission, a canvas, a platform 16, an electrical switch 14, a metal frame 10 and a protective cover 18.

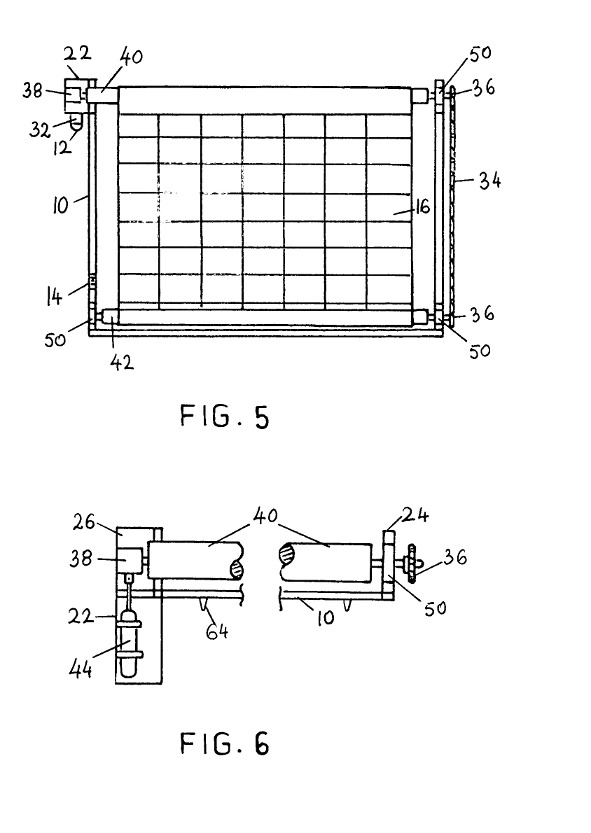

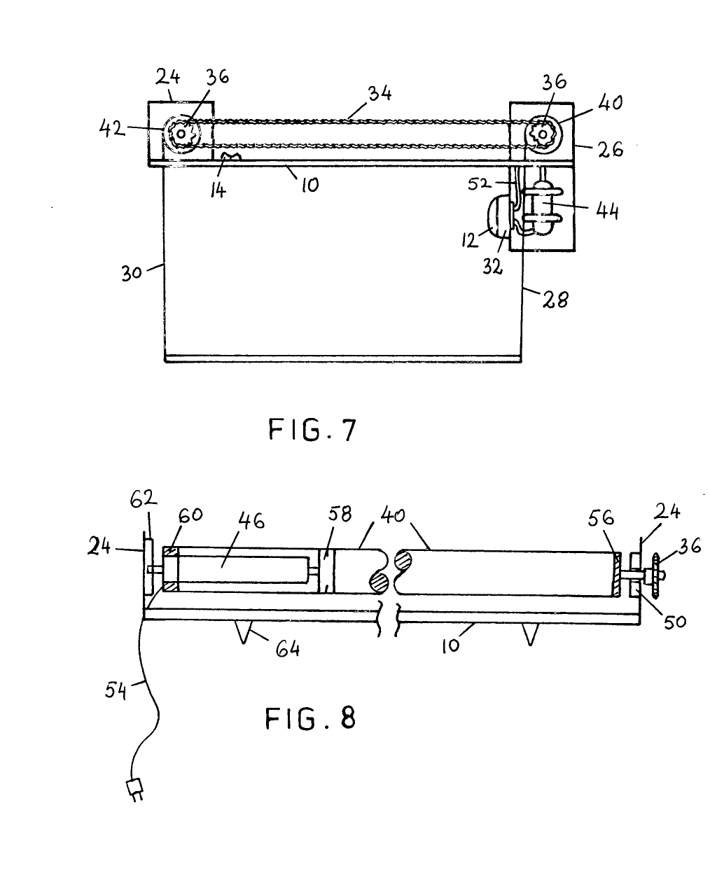

The metal frame 10 is used to serve as a superstructure for the parts and can be made of steel or aluminum and can fit different sizes of carts to provide flexibility in moving the lifting platform 16 from one cart 20 to another. It has two “u” locks 64 on one side of the frame 10 and two “u” locks 64 on the opposite side so it can sit securely on the top rim of a cart 20 frame 10. Also two brackets 24 on one side of the frame 10 and two brackets 24 on the opposite side are securely attached in the corners, as shown in FIG. 3, as to provide support for the rotating tubes. The brackets 24 can be welded or bolted to the frame 10. Protective cover 18 protect all the moving parts of the lifting platform 16 and is securely attached to the frame 10. The side of the frame 10, which is perpendicular to the rotating tubes, is where an electrical switch 14 is mounted, FIG. 5. It can be mounted on the left or right side. That part of the frame 10 is made of a hollow square tube, which accommodates an electrical switch 14 and also provides a safe conduit for an electrical cord 54 and electrical wires 52 from the power source and electrical motors (dc or ac). The electrical switch 14 is flush mounted in the frame 10 and is located close to the operator. The power tube 40 is installed between the brackets 24 with two bolts on each side. On one side of the power tube 40 installed in protection box are electrical dc motor with worm gear 38 and on the other side is bearing 50 with chain sprocket 36. On the opposite side is powered tube 42, installed between the brackets 24. On one side is bearing 50 and on the other side is chain sprocket 36. The tubes are connected by chain roller 34 over the chain sprockets and rotates by means of electrical dc motor simultaneously in the same direction at the same time and the same speed. The platform 16 hangs between the tubes on two pieces of canvas attached to the tubes. The electrical power is provided by battery pack 12 installed safely in battery dock 32 for easy removal.

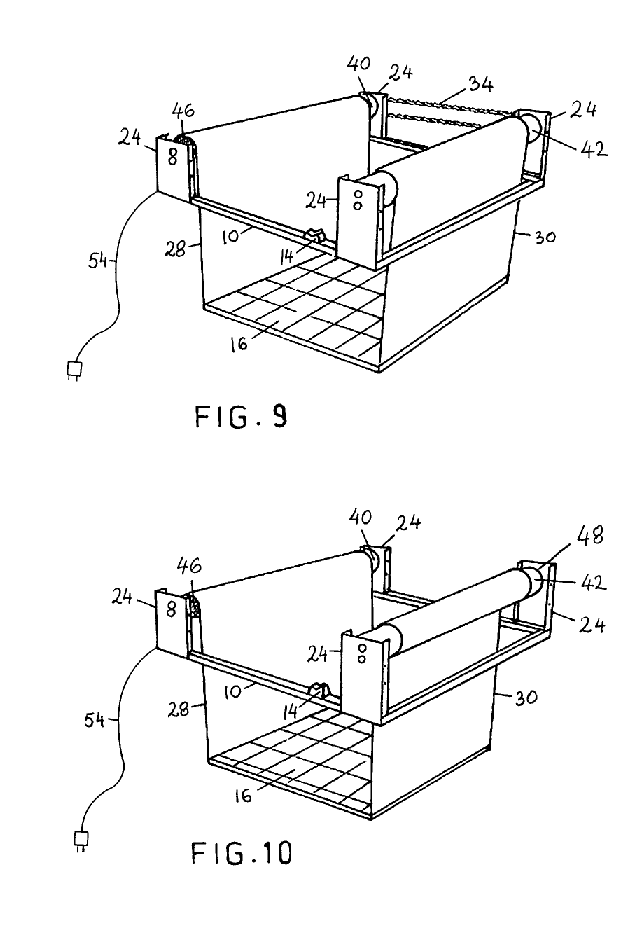

In another embodiment of the invention rotation of the tubes is provided by means of electrical ac tubular motor 1 46, with chain transmission and works on the same principle as shown in FIG. 9. In this case electrical ac tubular motor 1 46 fits inside the tube by means of crown 60 and drive 58 and at the end of the tube is idler 56. Idler 56 connects the end of the tube with chain sprocket 36 through the bearing 50. Drive 58 is attached to the shaft of the electrical ac tubular motor 1 46 and also to the tube to transfer the rotations of the motor to the tube. The crown 60 allows the electrical ac tubular motor 1 46 to fit inside the tube and allows the tube to rotate around the electrical ac tubular motor 1 46. Electrical ac tubular motor 1 46 head sits stationary in motor head bracket 62 attached to the frame 10 bracket.

In yet another embodiment rotation of the tubes is provided by means of two identical electrical ac tubular motors, installed in each tube. The electric ac tubular motors are wired together on the same switch and work simultaneously in same direction at the same time and at the same speed as shown in FIG. 10

The assembly is intentionally simple, to provide ease of fabrication and also to be maintenance free. The utility cart 20 lifting platform 16 is user friendly.

In operation the utility cart 20 lifting platform 16 is foolproof. The frame 10, as shown in FIG. 3. serves as a base for the elements of the utility cart 20 lifting platform 16 providing portability and can be made in different sizes to fit any existing or new carts in the market. The frame 10 gives the utility cart 20 lifting platform 16 the usability and look of a finished marketable product which is ready for use on all existing carts—simply put on top of a cart 20 and go. The “u” locks 64 on the bottom of the frame 10 provide a safe and secure fit on the top rim of the cart 20, wherein it improves the stability of the canvas/steel frame 10 carts. A hollow square tube with a slot for an electrical switch 14, that serves as a part of the frame 10, provides space for an electrical switch 14 to be mounted flush, so as not to be an obstacle for the contents of the cart 20 and also as a conduit for the electrical wires 52. One pair of wires connects electrical dc motor with a battery pack 12 and the other pair of wires connects the electrical switch 14 with battery pack 12. In the case when an electrical ac tubular motor 1 46 is used such as Model 510R, manufactured by Somfy Corp. of Mississauga, On, one cable is a power electrical cord 54 with a three pronged plug for 115V, 10 A electrical power and the other is a four wire electrical cord 54 from the electrical ac tubular motor/s. The rocker, momentary, electrical switch 14 is positioned on the opposite side of the power axle, ergonomically close to an operator and has two positions—up and down. It serves to control the travel of the lifting platform 16 up or down and as a safety device. An operator must keep a finger on the switch at all times during the travel of the lifting platform 16 and he/she controls precisely how long that travel will be—depending on the need. This means that the operator will not be rushed by the system and they can choose their own working pace. Loading the cart 20 with boxes requires the lifting platform 16 to travel down in increments of a few seconds to allow the operator to stack the boxes in the cart 20. The opposite operation—unloading asks for the same action. Both travels (up or down) are controlled by electrical switch 14 or are preset and controlled by limit switches built into the electrical ac tubular motor. This prevents any possible damage to the lifting platform 16 or the contents of the cart 20 caused by overtravel of the lifting platform 16 and provides the exact positioning of the lifting platform 16 every time the fitting platform 16 is used. The travel of the lifting platform 16 is provided by electrical dc motor connected to a worm gear 38 that rotates power and powered tubes clockwise/counterclockwise. The worm gear 38 is used to save the space (angled with a tube), reduces the speed and increase the torque. The electrical dc motor and worm gear 38 are installed in protective metal box which is attached to box bracket 26. The tubes are connected by steel chain roller 34 over chain sprockets instilled at the end of both tubes which enables them to rotate in same direction at the same time and the same speed. The support for the tubes is provided by selfaligning bearings attached to the frame 10 brackets 24. Two pieces of canvas, canvas “a” 28 and canvas “b” 30 are consequently attached to the power tube 40 and powered tube 42 and also to the platform 16 in such a way that the platform 16 stays horizontal at all times. The travel of the lifting platform 16 up or down is provided by winding/unwinding the canvases around the tubes and as a result lifting contents of the cart 20 to a waist-high level.

As it is shown in FIG. 9. in another embodiment where a electrical ac tubular motor 1 is used, the power tube 40 as shown in FIG. 8 is an assembly that provides the rotation of the steel tube like a torsion spring-loaded window rolleta, which uses the smallest possible space, and avoids mechanical problems of the spring, and is unaffected by the weight of the load. The electrical ac tubular motor 1 46 is equipped with built in limit switches and powerful brake which makes the travel of the lifting platform 16 smooth, horizontal and always at the same speed regardless of the power (means battery voltage) or of the quantity of the load or its weight. Once you determine the size of the steel tube, depending of the sized of the cart 20, you then choose the size of an electrical ac tubular motor 1 46 and crown 60, drive 58 and idler 56 that will fit the chosen steel tube. Crown 60 (bushing) will slide over the body of the electrical ac tubular motor 1 46 and is positioned on the motor head side providing the tube to rotate around an electrical ac tubular motor 1 46. Drive 58 (disk) will fit on the motor shaft and once the electrical ac tubular motor 1 46 is inserted inside the steel tube, it will be secured from the outside to the steel tube with selftapping screws. This will enable the rotations of the motor shaft to be transferred to the steel tube. At the opposite side of the tube as in FIG. 8 is idler 56 that provides the tube to connect with selfaligning bearing 50 and sprocket 36. The rotations of the powered tube 42 will be then achieved the same way by means of chain transmission. To avoid a chain transmission, and to increase safety and capacity of the lifting platform 16 we will use two electrical ac tubular motors. An electrical ac tubular motor 1 46 will we installed in power tube 40 and electrical ac tubular motor 2 48 will be installed in powered tube 42. They are identical and will be wired on the same switch to work simultaneously in the same direction, at the same time and at the same speed. The proper width and length of the canvas will be used to move the platform 16 up or down, depending of the size of the cart 20

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. An utility cart lifting platform for eliminating bending when loading and unloading utility carts. comprising:
means for providing a stationary frame;
means for providing electrical power for a dc motor;
means for providing control for electrical motors, switchably connected to said means for providing electrical power for a dc motor;
means for lifting the contents of a cart;
means for protecting moving parts of lifting platform aparatus, rigidly connected to said means for providing a stationary frame;
means for accomodating dc motor and worm gear assembly;
means for providing support for the tubes;
means for providing support for worm gear;
means for connecting platform with power tube, tangentially connected to said means for lifting the contents of a cart;
means for connecting platform to powered tube, tangentially connected to said means for lifting the contents of a cart;
means for providing safe and secure attachment for the battery;
means for accurete chain transmision from the power tube to the powered tube;
means for accomodate chain roller;
means for dc motor speed reduction and torque increase;
means for lifting one side of the platform by winding canvas “a” attached to it, rotatably connected to said means for accurete chain transmision from the power tube to the powered tube, securely connected to said means for connecting platform with power tube, and rotatably connected to said means for providing a stationary frame;
means for lifting the other side of the platform by winding canvas “b” attached to it, rotatably connected to said means for accurete chain transmision from the power tube to the powered tube, securely connected to said means for connecting platform to powered tube, and rotatably connected to said means for providing a stationary frame;
means for lifting platform to operate in cordless mode, providing tubes to rotate clockwise and counterclokwise, rigidly connected to said means for lifting one side of the platform by winding canvas “a” attached to it, and switchably connected to said means for providing control for electrical motors;
means for providing rotations for the power tube and by means of chain transmision to the powered tube;
means for providing rotations for the powered tube when chain transmision is not used;
means for providing support and rotations for the tubes;
means for connecting an electrical motor dc with the battery and the electrical switch;
means for providing electrical power for the electrical tubular motors;
means for providing connection between the tube and the bearing;
means for transfering rotations from the motor shaft to the tube and make the tube rotate;
means for providing rotatably snug fit of the tubular motor inside the tubes;
means for providing stationary support for the lectrical tubular motor head and the tube; and
means for the frame to sit securely on top rim of the cart.

2. The utility cart lifting platform in accordance with claim 1, wherein said means for providing a stationary frame. comprises a metal, made to fit any size of a cart frame.

3. The utility cart lifting platform in accordance with claim 1, wherein said means for providing electrical power for a dc motor. comprises a dry, deep cycle battery pack.

4. The utility cart lifting platform in accordance with claim 1, wherein said means for lifting the contents of a cart. comprises a flat, lightweight, washable platform.

5. The utility cart lifting platform in accordance with claim 1, wherein said means for connecting platform with power tube. comprises a fabric, washable canvas “a”.

6. The utility cart lifting platform in accordance with claim 1, wherein said means for connecting platform to powered tube. comprises a fabric, washable canvas “b”.

7. The utility cart lifting platform in accordance with claim 1, wherein said means for accurete chain transmision from the power tube to the powered tube. comprises a steel chain roller.

8. The utility cart lifting platform in accordance with claim 1, wherein said means for accomodate chain roller. comprises a steel sprocket.

9. The utility cart lifting platform in accordance with claim 1, wherein said means for dc motor speed reduction and torque increase. comprises a cast aluminum, variable ratio worm gear.

10. The utility cart lifting platform in accordance with claim 1, wherein said means for lifting platform to operate in cordless mode, providing tubes to rotate clockwise and counterclokwise. comprises a micro motor, high speed electrical dc motor.

11. The utility cart lifting platform in accordance with claim 1, wherein said means for providing rotations for the power tube and by means of chain transmision to the powered tube. comprises a fits inside the tube, with built-in limit switches, high torque, thermal protection from overload electrical ac tubular motor 1.

12. The utility cart lifting platform in accordance with claim 1, wherein said means for providing rotations for the powered tube when chain transmision is not used. comprises a fits inside the tube, with built-in limit switches, high torque, thermal protection against overload electrical ac tubular motor 2.

13. The utility cart lifting platform in accordance with claim 1, wherein said means for providing electrical power for the electrical tubular motors. comprises a flexible electrical cord.

14. The utility cart lifting platform in accordance with claim 1, wherein said means for providing connection between the tube and the bearing. comprises a fits diferent sizes of the tubes idler.

15. The utility cart lifting platform in accordance with claim 1, wherein said means for transfering rotations from the motor shaft to the tube and make the tube rotate. comprises a fits inside different sizes of the tubes drive.

16. The utility cart lifting platform in accordance with claim 1, wherein said means for providing rotatably snug fit of the tubular motor inside the tubes. comprises a fits different sizes of the tubes crown.

17. An utility cart lifting platform for eliminating bending when loading and unloading utility carts. comprising:
a metal, made to fit any size of a cart frame, for providing a stationary frame;
a dry, deep cycle battery pack, for providing electrical power for a dc motor;
a rocker, momentary electrical switch, for providing control for electrical motors, switchably connected to said battery pack;
a flat, lightweight, washable platform, for lifting the contents of a cart;
a metal, plastic protective cover, for protecting moving parts of lifting platform aparatus, rigidly connected to said frame;
a metal worm gear and dc motor box, for accomodating dc motor and worm gear assembly;
a metal, attached to the frame brackets, for providing support for the tubes;
a metal box bracket, for providing support for worm gear;
a fabric, washable canvas “a”, for connecting platform with power tube, tangentially connected to said platform;
a fabric, washable canvas “b”, for connecting platform to powered tube, tangentially connected to said platform;
a plastic, clik-in connection battery dock, for providing safe and secure attachment for the battery;
a steel chain roller, for accurete chain transmision from the power tube to the powered tube;
a steel sprocket, for accomodate chain roller;
a cast aluminum, variable ratio worm gear, for dc motor speed reduction and torque increase;
a metal power tube, for lifting one side of the platform by winding canvas “a” attached to it, rotatably connected to said chain roller, securely connected to said canvas “a”, and rotatably connected to said frame;
a metal powered tube, for lifting the other side of the platform by winding canvas “b” attached to it, rotatably connected to said chain roller, securely connected to said canvas “b”, and rotatably connected to said frame;
a micro motor, high speed electrical dc motor, for lifting platform to operate in cordless mode, providing tubes to rotate clockwise and counterclokwise, rigidly connected to said power tube, and switchably connected to said electrical switch;
a fits inside the tube, with built-in limit switches, high torque, thermal protection from overload electrical ac tubular motor 1, for providing rotations for the power tube and by means of chain transmision to the powered tube;
a fits inside the tube, with built-in limit switches, high torque, thermal protection against overload electrical ac tubular motor 2, for providing rotations for the powered tube when chain transmision is not used;
a selfaligning, flange bearing, for providing support and rotations for the tubes;
a flexible electrical wires, for connecting an electrical motor dc with the battery and the electrical switch;
a flexible electrical cord, for providing electrical power for the electrical tubular motors;
a fits diferent sizes of the tubes idler, for providing connection between the tube and the bearing;
a fits inside different sizes of the tubes drive, for transfering rotations from the motor shaft to the tube and make the tube rotate;
a fits different sizes of the tubes crown, for providing rotatably snug fit of the tubular motor inside the tubes;
a metal, atached to the frame bracket motor head bracket, for providing stationary support for the lectrical tubular motor head and the tube; and
a metal, attached to the frame “u” locks, for the frame to sit securely on top rim of the cart.

18. An utility cart lifting platform for eliminating bending when loading and unloading utility carts. comprising:
a metal, made to fit any size of a cart frame, for providing a stationary frame;
a dry, deep cycle battery pack, for providing electrical power for a dc motor;
a rocker, momentary electrical switch, for providing control for electrical motors, switchably connected to said battery pack;
a flat, lightweight, washable platform, for lifting the contents of a cart;
a metal, plastic protective cover, for protecting moving parts of lifting platform aparatus, rigidly connected to said frame;
a metal worm gear and dc motor box, for accomodating dc motor and worm gear assembly;
a metal, attached to the frame brackets, for providing support for the tubes;
a metal box bracket, for providing support for worm gear;
a fabric, washable canvas “a”, for connecting platform with power tube, tangentially connected to said platform;
a fabric, washable canvas “b”, for connecting platform to powered tube, tangentially connected to said platform;
a plastic, clik-in connection battery dock, for providing safe and secure attachment for the battery;
a steel chain roller, for accurete chain transmision from the power tube to the powered tube;
a steel sprocket, for accomodate chain roller;
a cast aluminum, variable ratio worm gear, for dc motor speed reduction and torque increase;
a metal power tube, for lifting one side of the platform by winding canvas “a” attached to it, rotatably connected to said chain roller, securely connected to said canvas “a”, and rotatably connected to said frame;
a metal powered tube, for lifting the other side of the platform by winding canvas “b” attached to it, rotatably connected to said chain roller, securely connected to said canvas “b”, and rotatably connected to said frame;
a micro motor, high speed electrical dc motor for lifting platform to operate in cordless mode, providing tubes to rotate clockwise and counterclokwise, rigidly connected to said power tube, and switchably connected to said electrical switch;
a fits inside the tube, with built-in limit switches, high torque, thermal protection from overload electrical ac tubular motor 1, for providing rotations for the power tube and by means of chain transmision to the powered tube;
a fits inside the tube, with built-in limit switches, high torque, thermal protection against overload electrical ac tubular motor 2, for providing rotations for the powered tube when chain transmision is not used;
a selfaligning, flange bearing, for providing support and rotations for the tubes;
a flexible electrical wires, for connecting an electrical motor dc with the battery and the electrical switch;
a flexible electrical cord, for providing electrical power for the electrical tubular motors;
a fits diferent sizes of the tubes idler, for providing connection between the tube and the bearing;
a fits inside different sizes of the tubes drive, for transfering rotations from the motor shaft to the tube and make the tube rotate;
a fits different sizes of the tubes crown, for providing rotatably snug fit of the tubular motor inside the tubes;
a metal, atached to the frame bracket motor head bracket, for providing stationary support for the lectrical tubular motor head and the tube; and
a metal, attached to the frame “u” locks, for the frame to sit securely on top rim of the cart.
